(19) United States
(12) Patent Application Publication
(10) Pub. No.: US 2024/0399647 A1
(43) Pub. Date: Dec. 5, 2024

(54) NUMERICAL CONTROLLER FOR FILAMENT WINDING MACHINE

(71) Applicants: Murata Machinery, Ltd., Kyoto-shi (JP); Toyota Jidosha Kabushiki Kaisha, Toyota-shi (JP)

(72) Inventors: Motohiro Tanigawa, Kyoto-shi (JP); Masatsugu Goyude, Kyoto-shi (JP); Toshihiro Matsui, Kyoto-shi (JP); Hirotaka Wada, Kyoto-shi (JP); Yoshihiro Kino, Kyoto-shi (JP); Hidehiro Takeoka, Kyoto-shi (JP); Yasuhiro Sakanashi, Kyoto-shi (JP); Dai Shimizube, Kyoto-shi (JP); Daigoro Nakamura, Kyoto-shi (JP); Wataru Sawabe, Toyota-shi (JP)

(73) Assignees: Murata Machinery, Ltd., Kyoto-shi (JP); Toyota Jidosha Kabushiki Kaisha, Toyota-shi (JP)

(21) Appl. No.: 18/677,084

(22) Filed: May 29, 2024

(30) Foreign Application Priority Data
May 30, 2023 (JP) 2023-088492

(51) Int. Cl. B29C 53/80; B29C 53/58; B29C 70/32; B29C 70/54; B29L 31/00; B65H 54/22

(52) U.S. Cl. CPC B29C 53/8041; B29C 53/58; B29C 70/32; B29C 70/54; B65H 54/22; B29L 2031/7156; B65H 2557/33; B65H 2557/60

(57) ABSTRACT

Control closely based on sets of winding data of a fiber bundle is performed even if at least one set of the winding data is skipped. A controller includes a data conversion unit, a reference data setting unit, a transfer unit, and a selector. The data conversion unit converts sets of first winding data generated based on winding conditions into sets of second winding data in which a processing order number is associated with information of a state of a winder. The reference data setting unit sets some of the second winding data as sets of reference data in advance. The transfer unit transfers a selected set of the second winding data to the winder, each time a unit time elapses. The selector is able to set an override value that is used for determining a skip number.

### CROSS-REFERENCE TO RELATED APPLICATION

This application claims the benefit of Japanese Pat. App. No. 2023-088492, filed on May 30, 2023, which application is incorporated herein by reference in its entirety.

### TECHNICAL FIELD

This disclosure relates to a numerical controller for a filament winding machine configured to control the filament winding machine.

### BACKGROUND

Japanese Laid-Open Patent Publication No. 2021-37702 discloses a filament winding machine including a winder for winding a fiber bundle onto a liner. More specifically, the fiber bundle is wound onto the outer surface of the liner in such a way that the fiber bundle is supplied from the winder to the liner while the winder and the liner are moved in parallel and rotated relative to each other. In this way, a product including the liner and the fiber bundle is produced. The operation of the winder is controlled by a controller.

As data for operations of the winder, it is possible by known software to generate plural sets of winding data (hereinafter, first winding data) in which various positional relationships between the winder and the liner (hereinafter, a state of the winder) are associated with time. The software is programmed to be able to generate plural sets of first winding data corresponding to a series of operations of the winder at the time of product production, based on conditions such as the length of the liner, the thickness (diameter) of the liner, a winding angle, and a time until the completion of winding.

To allow the controller to perform control of the winder based on plural sets of first winding data, conversion of the sets of first winding data into a predetermined number of sets of second winding data has been studied. The sets of second winding data are generated by interpolating the sets of first winding data, to enable various studies by lowering the operation speed (i.e., winding speed) of the winder compared to the operation speed in the product production. The controller sequentially transfers a predetermined set of second winding data selected from the sets of second winding data to the winder each time a predetermined unit time elapses (hereinafter, such a controller will be termed a numerical controller). If the numerical controller sequentially transfers all sets of second winding data to the winder, the slowest operations are performed among the operations utilizing the second winding data. As the numerical controller skips at least one set of the second winding data, operations quicker than the slowest operations can be performed. In other words, each time the unit time elapses, only sets of second winding data which are not skipped among the sets of second winding data are transferred to the winder. With this arrangement, the winding speed is increased.

However, if the numerical controller skips at least one set of second winding data, an operation that the winder must perform may be unintentionally skipped. In such a situation, there may be problems such as the deterioration in the quality of the product, because a winding position where a fiber bundle is wound may be deviated from a target position on the liner.

It could therefore be helpful to perform control closely based on sets of winding data of a fiber bundle even if at least one set of the winding data is skipped.

### SUMMARY

We thus provide:

According to a first aspect, a numerical controller for a filament winding machine, configured to control the filament winding machine including a winder configured to wind a fiber bundle onto a liner, includes: a data converter configured to be able to convert (i) sets of first winding data which are generated in advance based on a winding condition of winding the fiber bundle onto the liner and in each of which information of time is associated with information of a state of the winder into (ii) sets of second winding data in each of which information of a processing order number assigned to correspond to elapse of a predetermined unit time is associated with the information of the state of the winder; a reference data setter configured to be able to set some of the sets of the second winding data as sets of reference data in advance; a transferer configured to be able to transfer each of predetermined sets of winding data selected from the sets of the second winding data to the winder, each time the unit time elapses; an override value setter configured to be able to set an override value that is used for a skip number indicating the number of processing order numbers that are skipped when the predetermined sets of the winding data are selected; and an adjuster configured to be able to adjust the skip number at stages before and after each of reference numbers that are processing order numbers corresponding to the respective sets of the reference data, based on the override value, to allow the transferer to transfer all of the sets of the reference data to the winder.

The winding speed of the fiber bundle onto the liner is slowest when the transferer sequentially transfers all sets of the second winding data to the winder. Furthermore, some of the sets of the second winding data can be skipped in accordance with the override value. When the override value is the maximum (i.e., 100%), the winding speed is at the highest. The larger the override value is (i.e., the closer the override value is to 100%), the smaller the number of data sequentially transferred to the winder is, and the higher the winding speed is.

In addition to the above, the skip number is adjusted at the stages before and after each reference number. This makes it possible to transfer all sets of the reference data to the winder, even when the override value is large. On this account, it is possible to prevent an operation that the winder must perform from being skipped. It is therefore possible to perform control closely based on sets of winding data even if at least one set of the winding data (second winding data) of the fiber bundle is skipped.

According to a second aspect, the numerical controller of the first aspect is arranged so that the adjuster includes a level changer configured to be able to change an adjustment level that relates to an amount of change of the skip number at the stages before and after each reference number, in a state in which a set value of the override value is maintained at a predetermined value.

If the skip number is steeply adjusted immediately before or after the reference number, there is a possibility of rapid deceleration and rapid acceleration of the winder or the liner. This may cause a deviation of the winding position of the fiber bundle from the target position. In this regard, the adjustment level can be changed by the level changer. Because this makes it possible to gently adjust the skip number, rapid deceleration and rapid acceleration of the winder or the liner L are suppressed. It is therefore possible to perform control further closely based on the winding data.

According to a third aspect, the numerical controller of the second aspect is arranged so that the level changer is capable of differentiating the adjustment level at the stage before each reference number from the adjustment level at the stage after the each reference number.

This allows for flexible study as needed during the study phase to identify optimal manufacturing conditions for the product.

According to a fourth aspect, the numerical controller of any one of the first to third aspects is arranged so that the override value setter is configured to be able to switch the set value of the override value at a given timing, and when the override value is switched by the override value setter while the winder is in operation, the adjuster adjusts the skip number by comparing the override value after change with the override value before the change.

It is thus possible to adjust the skip number in consideration of the change of the override value. Therefore, even if the override value is changed while the winder is in operation, the reference data can be reliably transferred to the winder.

### BRIEF DESCRIPTION OF THE DRAWINGS

FIG. 1 is a perspective view showing a filament winding machine related to an example of the numerical controller described herein.

FIG. 2 is a block diagram showing an electrical structure of the filament winding machine.

FIG. 3(a) and FIG. 3(b) are front elevations of a helical winding unit.

FIG. 4 is a block diagram showing a more detailed electric structure of components such as a controller.

FIG. 5(a) is a table showing winding conditions, and FIG. 5(b) is a table showing plural sets of first winding data in tabular form.

FIG. 6 is a table showing plural sets of second winding data in tabular form.

FIGS. 7(a) and 7(b) are schematic graphs showing the positional relationship between a processing order number and a liner in a front-rear direction.

FIG. 8 shows an input screen of a selector.

FIG. 9(a) and FIG. 9(b) show means for adjusting a skip number in tabular form.

FIG. 10 is a flowchart showing the steps of the adjustment of the skip number.

FIG. 11(a) to FIG. 11(d) are schematic diagrams illustrating results of the adjustment of the skip number.

FIG. 12 is a schematic graph showing a state in which a process regarding a reference number is being reliably performed.

FIG. 13 is a flowchart showing a process performed when an override value is changed in the middle.

FIG. 14 is a flowchart showing part of the process shown in FIG. 13.

### DETAILED DESCRIPTION

### Filament Winding Device

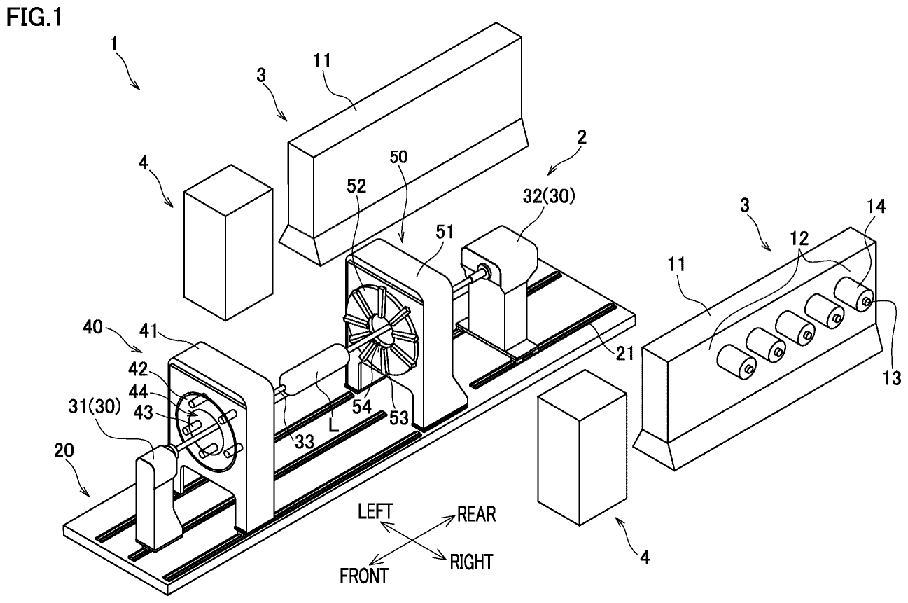

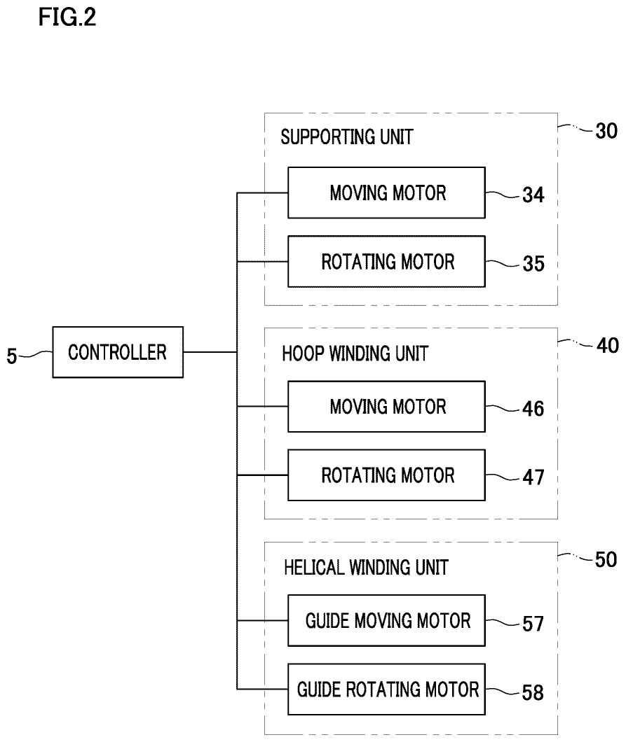

The following will describe an example of the numerical controller described herein. FIG. 1 is a perspective view showing a filament winding machine 1 related to this example. FIG. 2 is a block diagram of an electric configuration of the filament winding machine 1. For convenience of explanation, the directions (front-rear direction and left-right direction) shown in FIG. 1 are defined below. The front-rear direction and the left-right direction are directions parallel to the horizontal direction. The front-rear direction and the left-right direction are orthogonal to each other. Furthermore, the direction orthogonal to both the front-rear direction and the left-right direction is defined as an up-down direction. In this regard, the up-down direction is a vertical direction in which gravity acts.

A filament winding machine 1 is of a multiple-filaments feeding type, by which plural fiber bundles (not illustrated in FIG. 1) are simultaneously wound onto a liner L. The filament winding machine 1 includes a winder 2, creel stands 3, and pretreatment units 4. On the whole, the filament winding machine 1 is arranged to be substantially symmetrical in the left-right direction. The winder 2 winds fiber bundles onto a cylindrical liner L. Each fiber bundle is formed by, for example, impregnating a thermosetting or thermoplastic synthetic resin material into a fiber material such as carbon fiber. The shape of the liner L may vary depending on the final product. For example, when the final product is a pressure tank, the liner L having dome portions at both ends of a cylindrical portion as shown in FIG. 1 is used. The materials of the liner L include high-strength aluminum, metal, and resin. After the fiber bundles are wound onto the liner L, a thermosetting process such as baking or a cooling process is performed. As a result, a final product such as a high-strength pressure tank is produced.

The creel stands 3 are positioned on the both sides in the left-right direction of the winder 2, for example. The creel stands 3 are positioned, for example, in the vicinity of a rear end portion of the winder 2 in the front-rear direction. Each creel stand 3 has, for example, a substantially rectangular parallelepiped frame 11 that extends in the front-rear direction. The frame 11 is provided with, for example, one or more bobbin holder group 12. The bobbin holder group 12 is provided to correspond to each of nozzle units 53 of a later-described helical winding unit 50, for example. Each bobbin holder group 12 has a plurality of (five in the present example) bobbin holders 13 aligned in, for example, the front-rear direction. Each bobbin holder 13 has an axis that extends in the left-right direction, for example. Each bobbin holder 13 supports a bobbin 14 on which a fiber bundle is wound, in a rotatable manner. In this example, nine bobbin holder groups 12 are provided, and five bobbins 14 are attached to each bobbin holder group 12. (Therefore 45 bobbins 13 are provided in total.) From the five bobbins 14 belonging to each bobbin holder group 12, five fiber bundles are supplied together. The fiber bundles supplied from the creel stand 3 are wound onto the liner L by the helical winding unit 50. While FIG. 1 shows two creel stands 3, the number of the creel stands 3 is not limited to this. In addition, to avoid complication of the drawing, only one of the plural bobbin holder groups 12 is shown in FIG. 1.

The pretreatment units 4 are configured to perform a predetermined pretreatment (e.g., application of a tension) for the fiber bundles. The pretreatment units 4 are, for example, provided between the corresponding creel stands 3 and the helical winding unit 50 (described later) in the running direction of the fiber bundles.

### Winder

The following will describe a more specific arrangement of the winder 2. The winder 2 includes a base 20, supporting units 30 (a first supporting unit 31 and a second supporting unit 32), a hoop winding unit 40, and a helical winding unit 50.

The base 20 supports the supporting units 30, the hoop winding unit 40, and the helical winding unit 50. On the top surface of the base 20, rails 21 are provided to extend in the front-rear direction. The supporting units 30 and the hoop winding unit 40 are movable in the front-rear direction along the rails 21. On the other hand, the helical winding unit 50 is fixed in position relative to the base 20, for example. The first supporting unit 31, the hoop winding unit 40, the helical winding unit 50, and the second supporting unit 32 are provided in this order from the front side to the rear side.

The supporting units 30 include the first supporting unit 31 and the second supporting unit 32. The first supporting unit 31 is positioned forward of the hoop winding unit 40. The second supporting unit 32 is positioned rearward of the helical winding unit 50. Through a supporting shaft 33 which extends in the axial direction of the liner L (i.e., in the front-rear direction), the supporting units 30 support the liner L so that the liner Lis rotatable about the shaft. The supporting units 30 include a moving motor 34 and a rotating motor 35 (see FIG. 2). The moving motor 34 moves the supporting units 30 (the first supporting unit 31 and the second supporting unit 32) in the front-rear direction along the rails 21. The rotating motor 35 rotates the supporting shaft 33 so that the liner L is rotated about the shaft. The operations of the moving motor 34 and the rotating motor 35 are controlled by a controller 5.

The hoop winding unit 40 is configured to perform hoop-winding onto the circumferential surface of the liner L. The hoop winding is a way of winding the fiber bundles onto the liner L in a direction substantially orthogonal to the axial direction of the liner L. The hoop winding unit 40 includes, for example, a main body 41, a rotation member 42, and plural (five in the present example) bobbin holders 43. The main body 41 is movable in the front-rear direction along the rails 21. The rotation member 42 is an annular member with a passing hole 44 formed to allow the liner L to pass through. The rotation member 42 is supported by the main body 41 to be rotatable about the axis of the liner L. The bobbin holders 43 are attached to the rotation member 42 at regular intervals in the circumferential direction. Each bobbin holder 43 has a rotation shaft extending in the front-rear direction and supports a bobbin (not illustrated) on which a fiber bundle is wound, in a rotatable manner.

The hoop winding unit 40 includes a moving motor 46 and a rotating motor 47 (see FIG. 2). The moving motor 46 moves the main body 41 in the front-rear direction along the rails 21. The rotating motor 47 rotates the rotation member 42 about the axis of the liner L. The operations of the moving motor 46 and the rotating motor 47 are controlled by the controller 5. When the hoop-winding is performed, the controller 5 rotates the rotation member 42 while causing the main body 41 to reciprocate along the rails 21. Because of this, the fiber bundles are taken out from the respective bobbins rotating around the liner L, and are simultaneously hoop-wound onto the circumferential surface of the liner L.

The helical winding unit 50 is configured to perform helical-winding onto the circumferential surface of the liner L. The helical winding is a way of winding the fiber bundles onto the liner L in a direction substantially parallel to the axial direction of the liner L. The helical winding unit 50 includes, for example, a main body 51, a frame member 52, and plural (nine in the present example) nozzle units 53. The main body 51 is fixed to the base 20, for example. The frame member 52 is an annular member with a passing hole 54 formed to allow the liner L to pass through. The frame member 52 is supported by the main body 51. The nozzle units 53 are radially arranged around the axis of liner L. Each nozzle unit 53 is attached to the frame member 52.

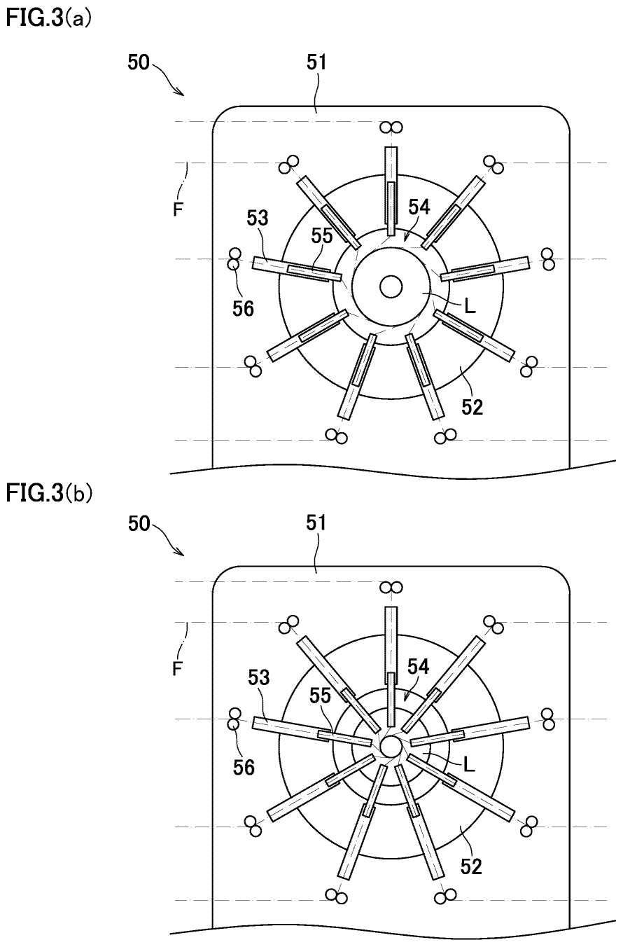

FIG. 3(a) and FIG. 3(b) are front elevations of the helical winding unit 50. To be more specific, FIG. 3(a) shows a situation when fiber bundles F are wound onto the cylindrical portion of the liner L. FIG. 3(b) shows a situation when fiber bundles F are wound onto the dome portion of the liner L. The nozzle unit 53 includes a guide member 55 guiding the fiber bundle F to the liner L. The guide member 55 extends in a radial direction of the liner L (hereinafter, this direction is simply referred to as the radial direction), and is configured to be movable in the radial direction and to be rotatable about a rotational axis extending in the radial direction. Radially outside each nozzle unit 53, a guide roller 56 is provided. The five fiber bundles F taken out from each bobbin holder group 12 of the creel stand 3 are introduced into one of the guide members 55 via the guide roller 56, and then supplied to the liner L from the leading end of the guide member 55.

The helical winding unit 50 includes a guide moving motor 57 and a guide rotating motor 58 (see FIG. 2). The guide moving motor 57 moves the guide members 55 simultaneously in the radial directions. The guide rotating motor 58 rotates the guide members 55 simultaneously about the rotational axis. The operations of the guide moving motor 57 and the guide rotating motor 58 are controlled by the controller 5. When the helical winding is performed, the controller 5 causes the liner L to pass through the passing hole 54 while slowly rotating the liner L about the axis. At the same time, the controller 5 suitably moves the guide member 55 of each nozzle unit 53 in the radial direction while rotating the guide member 55 of each nozzle unit 53 about the rotational axis. As a result, five fiber bundles F are properly pulled out from the leading end of the guide member 55 of each nozzle unit 53, and 45 fiber bundles F in total are simultaneously helical-wound onto the circumferential surface of the liner L.

### Further Details of Members Such As Controller

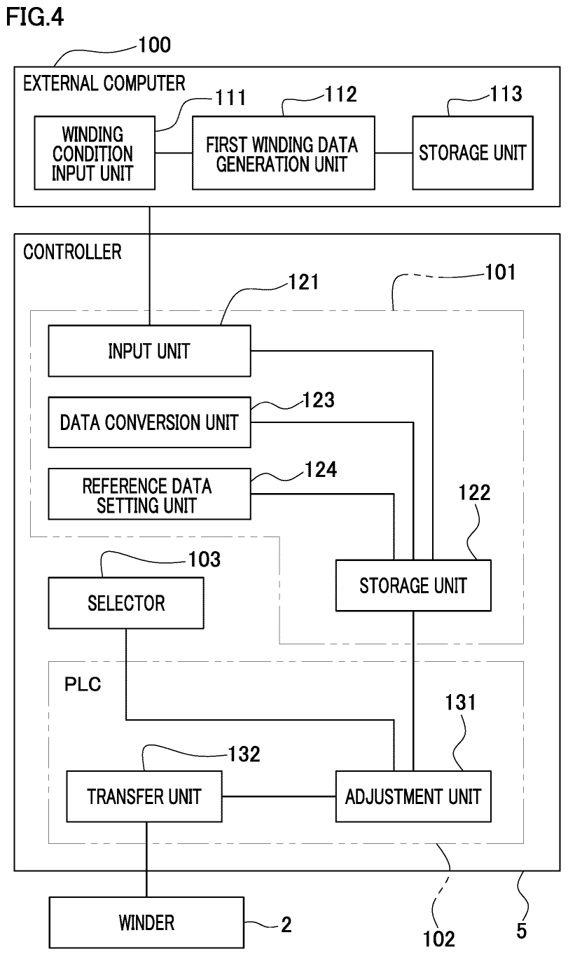

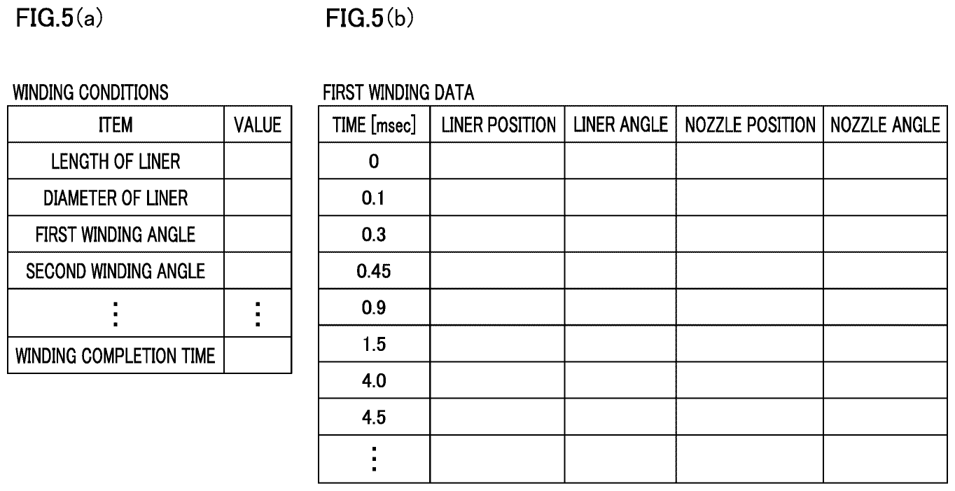

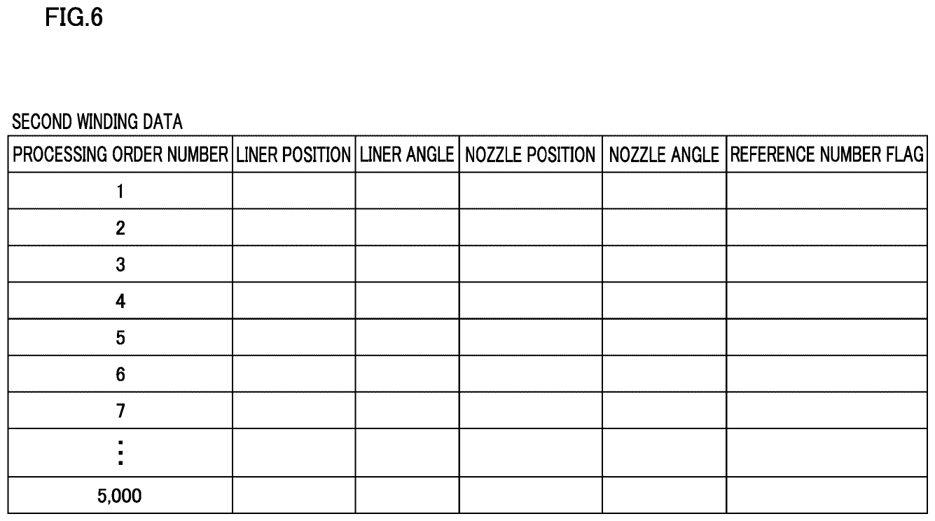

Further details of the members such as the controller 5 will be described with reference to FIG. 4 to FIG. 6. FIG. 4 is a block diagram showing a more detailed electric structure of the components such as the controller 5. FIG. 5(a) is a table showing winding conditions (described later). FIG. 5(b) is a table showing plural sets of first winding data generated by converting the winding conditions, in tabular form. FIG. 6 is a table showing plural sets of second winding data (described later) generated by converting sets of first winding data, in tabular form.

The controller 5 (numerical controller) is configured to cause the winder 2 to perform operations (hereinafter, winding operations) based on a predetermined program, by utilizing plural sets of data (hereinafter, winding data which will be specifically described below) for controlling the winder 2. The controller 5 includes, for example, a computer 101, a programmable logic controller (PLC) 102, and a selector 103 (override value setter and level changer). The computer 101 is, for example, a typical computer device. The computer 101 is configured to be able to generate plural sets of winding data (later-described second winding data) used by the PLC 102.

The PLC 102 is configured to be able to select a predetermined set of second winding data from plural sets of second winding data and send (transfer) the selected set of second winding data to the winder 2, each time a predetermined unit time elapses. The selector 103 is configured to switch a method of selection of the second winding data by the PLC 102 according to need.

The computer 101 may be connected to another external computer 100 that is a typical computer device, for example. The external computer 100 is configured to be able to generate a first winding data group (see FIG. 5(b)) including plural sets of first winding data, based on data of the winding conditions (see FIG. 5(a)). The external computer 100 includes, for example, a winding condition input unit 111, a first winding data generation unit 112, and a storage unit 113.

The winding condition input unit 111 includes, for example, a keyboard, a mouse, and/or a touch panel that are not illustrated. The winding condition input unit 111 is configured to allow an operator to input winding conditions. The winding conditions are basic conditions required to wind a fiber bundle F onto a liner L. For the sake of simplicity, the following will describe winding conditions of a helical winding unit 50 as an example. The winding conditions include, for example, the length of a liner L onto which a fiber bundle Fis wound, the thickness (diameter) of the liner L, the winding angle of the fiber bundle F wound onto the liner L, and a required time from the start to the completion of the winding (see a winding completion time in FIG. 5(a)). FIG. 5(a) shows only the above-described parameters, and specific numerical values are omitted. In general, a fiber bundle F is wound onto the liner L to form multiple layers. Therefore, multiple conditions are typically input regarding the winding angle.

The first winding data generation unit 112 is configured to generate plural sets of first winding data (see FIG. 5(b)) in which time is associated with information of the state of the winder 2, based on the winding conditions. The first winding data generation unit 112 can generate plural sets of first winding data by, for example, using commercially available software. An examples of the software is CADWIND (trademark) made by MATERIAL. The information of the state of winder 2 includes, for example, the position (liner position) of the liner L in the front-rear direction, the rotation angle (liner angle) of the liner L around its axis, the position (nozzle position) of the nozzle unit 53 in the radial direction of the liner L, and the rotation angle (nozzle angle) of the nozzle unit 53. In other words, each set of first winding data is, for example, a set of data in which a time elapsed from the start of the winding operation, the liner position, the liner angle, the nozzle position, and the nozzle angle are associated with one another (see FIG. 5(b)). In FIG. 5(b), specific numerical values other than the time are omitted. Plural sets of first winding data constitute a single first winding data group. The first winding data group is generated, for example, in advance before the controller 5 starts the operation of the winder 2. A time interval between a set of first winding data and an adjacent set of first winding data may not be constant in the sets of first winding data. This is because a series of steps of the winding operation may include both a timing at which the winder 2 is greatly driven in a short time and a timing at which the winder 2 is gradually driven over a certain length of time. When the CADWIND is used, a single first winding data group corresponding to one nozzle unit 53 is generated. An operator performing a task of generating the first winding data group may, for example, sequentially generate multiple first winding data groups corresponding to the respective nozzle units 53. Alternatively, the operator may generate a first winding data group corresponding to a nozzle unit 53 and then convert the first winding data group to at least one first winding data group corresponding to another nozzle unit 53, by using any means. As a matter of course, plural first winding data groups may be generated at once by using another piece of software.

The storage unit 113 is configured to be able to store at least the first winding data group. In place of the storage unit 113, for example, a removable storage medium (not illustrated) that is attachable to and detachable from both of the external computer 100 and the computer 101 may be provided.

Alternatively, the computer 101 may have some or all functions of the external computer 100.

The computer 101 includes an input unit 121, a storage unit 122, a data conversion unit 123 (data converter), and a reference data setting unit 124 (reference data setter). The input unit 121 allows an input of at least the first winding data. The storage unit 122 is configured to be able to store various types of data.

The data conversion unit 123 is configured to be able to convert the first winding data group (see FIG. 5(b)) to a predetermined second winding data group (see FIG. 6). The second winding data group includes plural sets of second winding data read by the PLC 102. Each of the sets of second winding data is data for allowing the PLC 102 to perform transfer to the winder 2 each time a predetermined unit time elapses (i.e., at constant time intervals). More specifically, the data conversion unit 123 interpolates sets of first winding data by using, for example, a known interpolation method, and generates plural sets of second winding data as plural sets of winding data at regular time intervals. Examples of the interpolation method include spline interpolation and linear interpolation. The unit time may vary depending on, for example, the specifications of the PLC 102. In the present example, the unit time is, for example, 2 msec. The value of time included in each set of first winding data does not need to be a multiple of the unit time.

Each set of second winding data is, for example, a set of data in which a processing order number, the liner position, the liner angle, the nozzle position, and the nozzle angle are associated with each other (see FIG. 6). In FIG. 6, specific numerical values other than the processing order number are omitted. The processing order number is a consecutive number assigned to each set of second winding data in accordance with each unit time. The number of sets of second winding data included in a single second winding data group is equal to the number of processing order numbers. A non-limiting example of the number of processing order numbers is 5000 (see FIG. 6). The second winding data group is generated, for example, in advance before the controller 5 starts the operations of the winder 2. As described below, all or some of the sets of second winding data are transferred to the winder 2 by the PLC 102.

The reference data setting unit 124 is used to set a specific set of second winding data as reference data among the plural sets of second winding data. The details will be given later.

The PLC 102 is, for example, a known computer suitable for controlling machines. Based on a predetermined program, the PLC 102 is configured to be able to receive sets of second winding data from the computer 101, sequentially select predetermined sets of second winding data from the sets of second winding data, and transfer the selected sets of second winding data to the winder 2. The PLC 102 includes, for example, an adjustment unit 131 (adjuster) and a transfer unit 132 (transferer).

The adjustment unit 131 is configured to sequentially select sets of second winding data which should be transferred to the winder 2, from the sets of second winding data generated by the computer 101. A specific selection method (adjustment method) of selecting (adjusting) the second winding data by the adjustment unit 131 will be described later.

The transfer unit 132 is configured to transfer the set of second winding data selected by the adjustment unit 131 to the winder 2, each time the unit time elapses.

The selector 103 is an input operation terminal configured to be able to receive an input from, for example, an operator. The selector 103 is electrically connected to, for example, the PLC 102. The selector 103 is configured to be able to switch the adjustment method (described later) performed by the adjustment unit 131. The following explains “override” and “override value” related to the adjustment method.

In the present example, “override” refers to a function of changing the winding speed at which a fiber bundle F is wound onto the liner L by the winder 2. The winding speed is not information that is expressed in a specific numerical value but a concept that serves as an index of the speed at which the fiber bundle F is wound onto the liner L. The winding speed increases as the time (winding time) from the start of winding of a fiber bundle F onto the liner L by using all or some of the sets of second winding data in the second winding data group to the completion of the winding decreases. On this account, the longer the winding time is, the slower the winding speed is. A purpose of changing the winding speed is to enable detailed study such as confirmation of the winding position of the fiber bundle F on the outer surface of liner L, before determining conditions (hereinafter, production conditions) for producing a product by winding the fiber bundle F onto the liner L. A function that enables such study is referred to as override, for convenience of explanation.

The winding speed in the product production is referred to as the maximum winding speed for convenience of explanation. When the above-described study is conducted, a winding speed slower than the maximum winding speed can be set by the selector 103 by using the override function. The rate (%) of the set winding speed relative to the maximum winding speed is referred to as an override value for the sake of convenience. The override value is a rate with the assumption that the maximum winding speed is 100%. The override value is larger than 0 and is equal to or smaller than 100%. The selector 103 of the present example is configured to be able to switch (set) the override value within, for example, 10% to 100%. In the present example, selectable (settable) override values are predetermined discontinuous values, such as 10%, 30%, 50%, and 100%, for example. Hereinafter, an override value having been selected (set) by the selector 103 may be referred to a set value of the override value. The selector 103 is configured to be able to transfer information of the set value of the override value to the PLC 102 at, for example, predetermined time intervals (e.g., each time the above-described unit time elapses). The override value is used also for determining a later-described skip number.

### Basic Adjustment

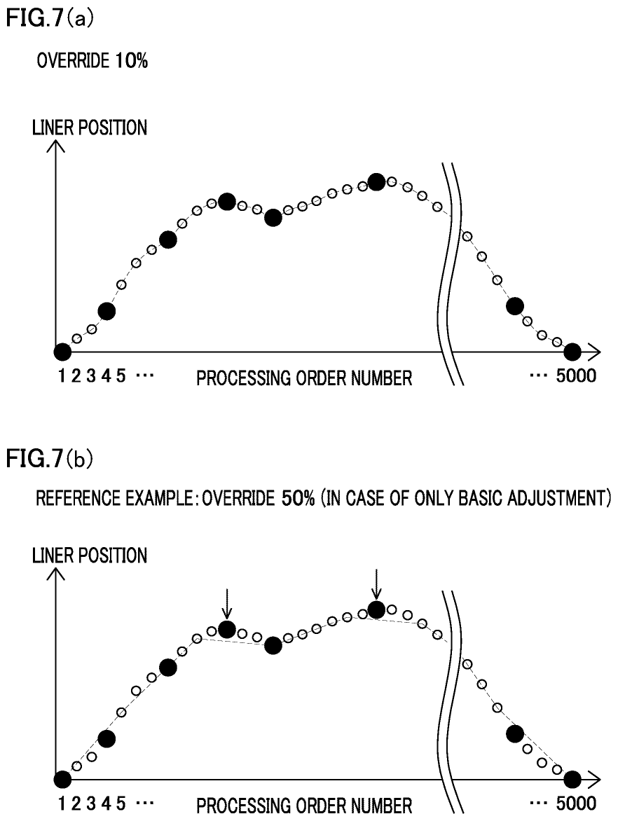

The following will describe basic adjustment performed by the adjustment unit 131 of the PLC 102 based on an override value, with reference to FIG. 7(a) and FIG. 7(b). FIGS. 7(a) and 7(b) are schematic graphs showing the relationship between a processing order number and the position (hereinafter, liner position) of the liner L in the front-rear direction.

When the override value is at its minimum (10% in the present example), the adjustment unit 131 sequentially selects all sets (5000 in the present example) of the second winding data included in the second winding data group. On this account, the transfer unit 132 sequentially transfers all sets of second winding data to the winder 2 over the unit times. In this way, the winder 2 slowly performs the winding operation over a time (hereinafter, maximum time) that is calculated by multiplying the unit time by the total number of sets of the second winding data. On this account, control that is closely based on all sets of second winding data is performed (see FIG. 7(a)), and the fiber bundle is wound onto a desired location on the liner L. In the present example, the maximum time is approximately 10 times as long as the time from the start to the completion of the winding operations when the override value is 100%. In this regard, as shown in FIG. 7(a), for example, the liner position (position in the front-rear direction of the liner L) is at a desired position at each time point. The same applies to the other parameters such as the liner angle, the nozzle position, and the nozzle angle.

When the override value is different from the minimum value, the adjustment unit 131 sequentially selects some sets of the second winding data (hereinafter, predetermined sets of winding data). For example, when the override value is 50% (see FIG. 7(b)), basically, the adjustment unit 131 sequentially selects only about 1000 sets of second winding data out of 5000 sets of second winding data. More specifically, for example, the adjustment unit 131 selects sets of second winding data corresponding to processing order numbers 1, 5, 10, 15, 20, etc. In other words, the adjustment unit 131 selects sets of the second winding data while causing the transfer unit 132 to skip some processing order numbers (e.g., 2, 3, 4, 6, 7, 8, 9, etc.). To put it differently, the adjustment unit 131 basically performs a process of skipping a predetermined number of sets of second winding data, based on the override value. The transfer unit 132 sequentially transfers the sets of second winding data (predetermined sets of winding data) selected by the adjustment unit 131 to the winder 2 over the unit times.

Hereinafter, for the sake of convenience, the number of processing order numbers each of which is skipped each time the unit time elapses is referred to as a skip number. Furthermore, the above-described predetermined number is referred to as a basic skip number. The basic skip number is a type of the skip number. The basic skip number is a numerical value obtained in such a way that the set value of the override value is divided by 10 and the value obtained by the division is multiplied by 100. For example, the basic skip number when the set value of the override value is 50% is 5. For example, the basic skip number when the set value of the override value is 100 is 10.

In this way, each time the unit time elapses, only a set of second winding data (i.e., predetermined sets of winding data) which is not skipped among the sets of second winding data is transferred to the winder 2, with the result that the winding speed is increased. More specifically, when the override value is 50%, it is possible to cause the winder 2 to perform the winding operation at a winding speed that is about five times faster than the winding speed when the override value is 10%.

However, if the controller 5 skips at least one set of second winding data, an operation that the winder 2 must perform may be unintentionally skipped. For example, assume that the liner L needs to be positioned at a liner position indicated by a filled circle at a predetermined time point, as shown in the referential drawing in FIG. 7(b). In this situation, if only basic adjustment is performed to skip sets of second data, the number of which is identical with the basic skip number (see a broken line), the liner L may not be positioned at desired positions at predetermined time points (see downward arrows in FIG. 7(b)). In such a situation, there may be problems such as the deterioration in the quality of the product, because a winding position where the fiber bundle F is wound is deviated from a target position on the liner L. Therefore, to perform control closely based on the second winding data even if some sets of the second winding data are skipped, the controller 5 is configured as described below.

### Overview

Before providing a detailed explanation, an overview of the processes performed by the controller 5 will be given. The controller 5 is configured to able to set some sets of second winding data related to operations that the winder 2 must perform as sets of reference data, among the sets of second winding data. The PLC 102 is programmed to be able to select sets of second winding data so that the transfer unit 132 certainly transfers the sets of reference data to the winder 2. For the sake of convenience, the process performed by the adjustment unit 131 for this selection is referred to as a smoothing process. Roughly speaking, the smoothing process is a process of adjusting the skip number to a number smaller than the basic skip number at a stage before and after the processing order number (hereinafter, a reference number) corresponding to each of sets of reference data.

### Reference Data

The following will describe means for setting the reference data. As described above, the computer 101 of the controller 5 includes a reference data setting unit 124 (see FIG. 4). The reference data setting unit 124 is used to set some sets of the second winding data as plural sets of the reference data. The reference data setting unit 124 is configured to be able to accept an operational input made by an operator, for example. The reference data setting unit 124 can turn a reference number flag on or off in response to an operational input made by the operator. The reference number flag is a flag that indicates whether a set of the second winding data corresponding to each processing order number is the reference data or not. When a reference number flag associated with a processing order number is on, a set of the second winding data corresponding to that processing order number is a set of the reference data. Furthermore, the processing order number is a reference number. When the flag is off, a set of the second winding data corresponding to the processing order number is not a set of the reference data. Sets of winding data updated by the reference data setting unit 124 are, for example, stored in the storage unit 122.

In the present example, the operator operates the computer 101 to set plural sets of reference data in advance, before the controller 5 starts the operations of the winder 2. The operator may set plural sets of reference data based on any of the liner position, the liner angle, the nozzle position, and the nozzle angle that are described above. A reference number flag corresponding to the first processing order number (“1” in the present example) and a reference number flag corresponding to the last processing order number (“5000” in the present example) are normally set at on.

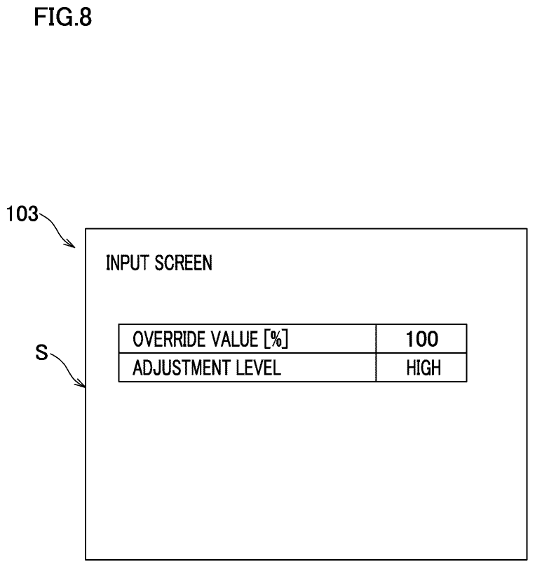

The following will briefly describe the selector 103 with reference to FIG. 8. FIG. 8 shows an input screen S of the selector 103. The selector 103 is configured to be able to switch the set value of the override value as described above (see FIG. 8). The operator is able to perform the switching of the override value by operating the selector 103. The selector 103 is configured to be able to change the level (hereinafter, adjustment level; see FIG. 8) of the smoothing process while the set value of the override value is maintained at a predetermined value. The selector 103 is configured to be able to change the adjustment level between, for example, “low”, “middle”, and “high” (“high” is selected in FIG. 8). Basically, the higher the adjustment level is, the longer the time during which the adjustment of the skip number is performed is (i.e., the more smoothly the adjustment is performed). The details will be given later.

### Smoothing Process

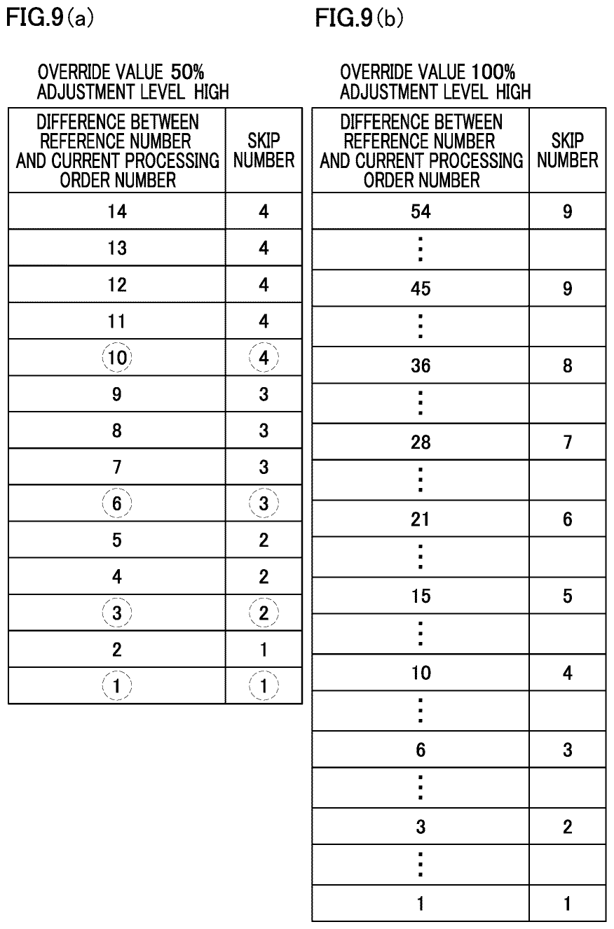

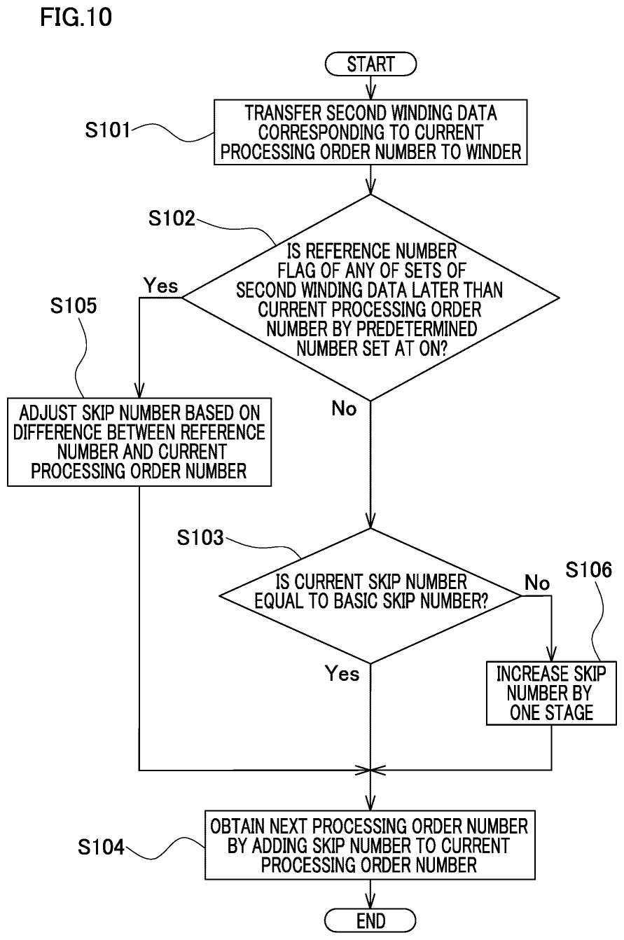

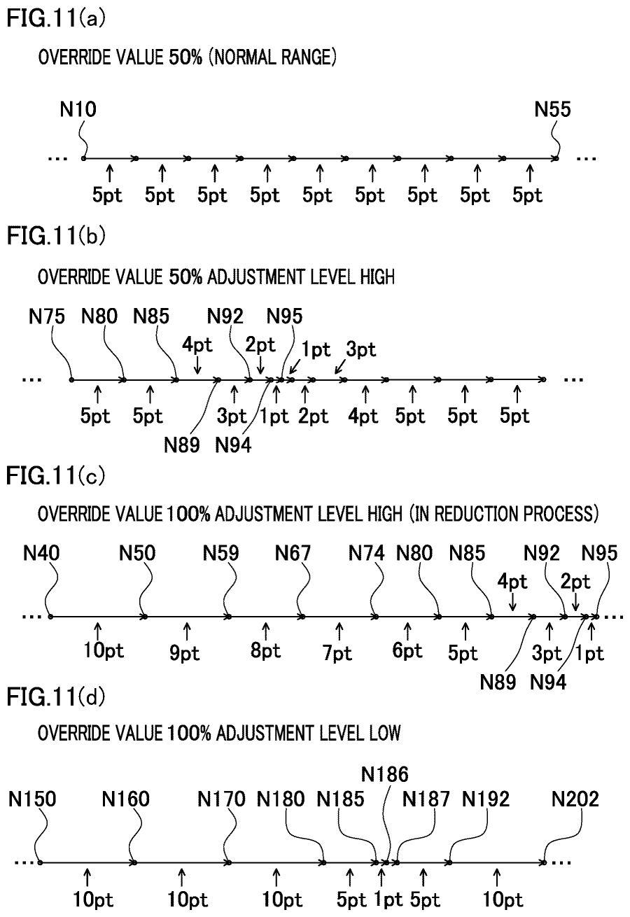

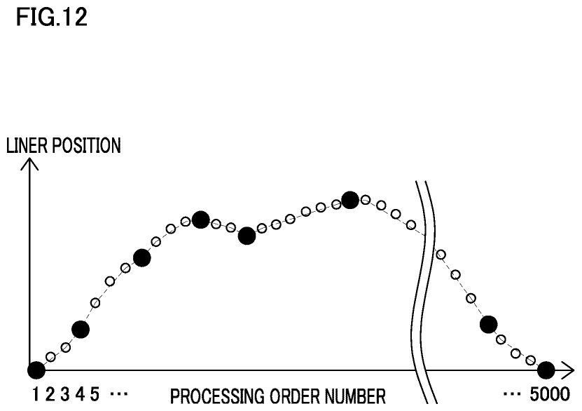

The smoothing process (i.e., adjustment of the skip number) will be explained with reference to FIG. 9(a) to FIG. 12. FIG. 9(a) and FIG. 9(b) show an adjuster for adjusting the skip number in tabular form. FIG. 10 is a flowchart showing the steps of the adjustment of the skip number. FIG. 11(a) to FIG. 11(d) are schematic diagrams illustrating results of the adjustment of the skip number. FIG. 12 is a schematic graph showing a state in which a process regarding a reference number is being reliably performed. Processing order numbers corresponding to sets of reference data (indicated by filled circles) in FIG. 12 are provided at short intervals solely for the sake of explanation. These processing order numbers do not correspond to the processing order numbers of the reference data in the explanations based on other drawings.

To begin with, means for performing the smoothing process will be described with reference to FIG. 9(a) and FIG. 9(b). The PLC 102 is configured to perform various operations such as calculations and controls based on predetermined programs, each time the unit time elapses. Hereinafter, for the sake of convenience, such various calculations and controls will be collectively referred to as periodic control. A cycle of the periodic control will be referred to as a control cycle. The length of the control cycle is equal to the length of the unit time, for example.

The PLC 102 is programmed to have functions described below, for example. In each control cycle, the PLC 102 can grasp a processing order number in the current control cycle (hereinafter, this may be simply referred to as “current”). In each control cycle, the PLC 102 is able to grasp a current skip number. In each control cycle, the PLC 102 is capable of reading reference number flags related to processing order numbers ranging from a current processing order number to a processing order number that is later than the current processing order number by a predetermined number. The PLC 102 is able to determine whether a reference number flag having been read is on or off. The predetermined number may be changed in accordance with the override value and the adjustment level. For example, when the override value is 50% and the adjustment level is high, the predetermined value may be 14 (see FIG. 9(a)). For example, when the override value is 100% and the adjustment level is high, the predetermined value may be 54 (see FIG. 9(b)). Alternatively, the predetermined number may be constant irrespective of the override value and the adjustment level. In other words, the predetermined number may be the maximum conceivable number.

The PLC 102 is able to adjust the skip number based on a difference (hereinafter, this may be simply referred to as a differential value) between a processing order number (i.e., a reference number) determined to correspond to a reference number flag that is turned on and a current processing order number. For example, as shown in FIGS. 9(a) and 9(b), the PLC 102 stores plural sets of data (data group) in which differential values are associated with skip numbers. Hereinafter, this data group will be referred to as a skip number data group. The skip number data group is stored in advance in the PLC 102 to correspond to each override value and each adjustment level. In a single skip number data group, the smaller the differential value is, the smaller the skip number is (see, e.g., FIG. 9(a)). The PLC 102 is able to obtain the skip number by reading predetermined data in a predetermined skip number data group based on an override value, an adjustment level, a current processing order number, and a reference number. Alternatively, the PLC 102 may be programmed to obtain the skip number through a calculation, based on an override value, an adjustment level, a current processing order number, and a reference number.

The PLC 102 is able to store a current override value, an override value in the immediately preceding control cycle (hereinafter, this cycle is simply referred to as “directly preceding override value”), and a set value of the override value input from the selector 103. A process performed by utilizing this function will be described later.

### Example of Adjustment of Skip Number

The following will describe an example of steps of adjustment of the skip number and an example of a result of the adjustment of the skip number, with reference to a flowchart shown in FIG. 10 and FIG. 11(a) to FIG. 11(d). For the sake of simplicity, the following will describe periodic control performed when the override value and the adjustment level are constant from the start to the end of the winding operations. A process performed when the set value of the override value is varied during a period from the start to the end of the winding operations will be described later. Furthermore, for the sake of simplicity, it is assumed that there are a sufficient number of processing order numbers between a reference number and the next reference number. It is further assumed that a process of transferring the second winding data to the winder 2 is performed by the transfer unit 132 of the PLC 102 whereas other processes are performed by the adjustment unit 131 of the PLC 102.

In the periodic control, to begin with, the PLC 102 grasps a current processing order number and a current skip number. For example, the PLC 102 transfers a set of second winding data corresponding to the current processing order number to the winder 2 (S101). Subsequently, the PLC 102 reads sets of second winding data corresponding to processing order numbers ranging from the current processing order number to a processing order number later than the current processing order number by a predetermined number. The PLC 102 determines whether a reference number flag of any of the sets of winding data having been read is set at on (S102). When all reference number flags are off (No in S102), the PLC 102 determines whether the current skip number is equal to the basic skip number (S103). If the current skip number is equal to the basic skip number (Yes in S103), the PLC 102 obtains the next processing order number by adding the current skip number to the current processing order number (S104). The next processing order number is used when the next periodic control (i.e., periodic control after the elapse of the unit time) is performed. The above-described process is a process in a range in which the smoothing process is unnecessary. This range indicates a range of processing order numbers existing between given two processing order numbers. (The two processing order numbers are included in the range.) Hereinafter, the range in which the smoothing process is unnecessary may be termed a normal range. A range in which the smoothing process is necessary may be termed a smoothing range.

As a more specific example, the following will explain a processing result in a normal range when the set value of the override value is 50%, with reference to FIG. 11(a). For example, when the smoothing process is unnecessary in a range between a processing order number 10 (see N10 in FIG. 11(a)) and a processing order number 55 (see N55 in FIG. 11(a)), at least the range between N10 and N55 is a normal range. In the normal range, the skip number is maintained to be constant. The skip number is 5 that is equal to the basic skip number (see “5 pt” in FIG. 11(a)).

Now, the following will describe an example where the smoothing process is necessary, with reference to a flowchart of FIG. 10. When the reference number flag of any of sets of winding data having been read is set at on (Yes in S102), the PLC 102 adjusts the skip number based on a difference (i.e., a differential value) between the reference number and the current processing order number (S105). Then the PLC 102 obtains the next processing order number by adding the adjusted skip number to the current processing order number (S104). A specific example of the step S105 is as follows: the PLC 102 selects a skip number associated with the differential value, from a skip number data group corresponding to the current override value and the adjustment level. The PLC 102 sets the selected skip number as the current skip number. Although not specifically shown in the flowchart, when the current differential value is included in the sets of data in the skip number data group (i.e., when the current processing order number falls within the smoothing range), the PLC 102 performs adjustment of the skip number. When the sets of data in the skip number data group do not include the current differential value, the PLC 102 does not perform the adjustment of the skip number.

Assume that the set value of the override value is 50% and the adjustment level is high (see FIG. 9(a)). When the differential value is 10, the skip number is set at 4 (see the number encircled by a dotted line in FIG. 9(a)). Then the PLC 102 obtains the next processing order number by adding this skip number to the current processing order number in the step S104. As a result, in the next control cycle, the differential value is 6 and the skip number is set at 3 (see the number encircled by dotted lines in FIG. 9(a)). Then the next processing order number is obtained in the same way. In the next after next control cycle, the differential value is 3 and the skip number is set at 2. In the subsequent control cycle, the differential value is I and the skip number is set at 1. In this way, the process of sequentially decreasing the skip number is performed each time the unit time elapses. Hereinafter, such a process is referred to as a reduction process for the sake of convenience.

A result of the reduction process when the set value of the override value is 50% and the adjustment level is high will be described with reference to FIG. 11(b). For example, assume that one of the reference numbers is 95 (see N95 in FIG. 11(b)). When the current processing order number is, for example, 75 or 80 (see N75 and N80 in FIG. 11(b)), the smoothing process is not necessary yet. When the current processing order number becomes 85, the reduction process starts. As a result, the skip number decreases to 4, 3, 2, and 1, and the processing order number is changed to N85, N89, N92, N94, and N95. As the reduction process is performed in this way, the set of second winding data corresponding to the reference number (95 in this example) is reliably transferred to the winder 2.

The following will describe a process performed when the set value of the override value is 50%, the adjustment level is high, and the current processing order number is larger than the reference number, again with reference to the flowchart in FIG. 10. When all reference number flags are off (No in S102) and the current skip number is different from the basic skip number (No in S103), the PLC 102 increases the skip number by one stage (S106). This increase by one stage indicates that, each time the unit time elapses, the decreased skip number is restored (increased) stepwise, e.g., to 2, 3, 4, and then 5. Then the PLC 102 obtains the next processing order number by adding the increased skip number to the current processing order number (S104). By repeating this step, the skip number decreased in the reduction process returns to the basic skip number. Hereinafter, such a process of restoring (increasing) the skip number will be referred to as an increase process for the sake of convenience.

In the flowchart shown in FIG. 10, the periodic control is completed when the step S104 is executed, no matter which one of the above-described conditional branch is executed. In the next control cycle, the PLC 102 treats the processing order number obtained in the directly preceding cycle as the current processing order number.

The following will briefly explain an example in which the set value of the override value is a different value. For example, when the set value of the override value is 100% and the adjustment level is high, a skip number data group shown in FIG. 9(b) is used. A result of the reduction process is, for example, a result shown in FIG. 11(c). Assume that, for example, the reference number is 95. When the current processing order number is, for example, 40 (see N40 in FIG. 11(c)), the smoothing process is not necessary yet. When the current processing order number reaches 50, the reduction process starts. The skip number decreases to 9, 8, 7, 6, 5, 4, 3, 2, and 1. The processing order number becomes N50, N59, N67, N74, N80, N85, N89, N92, N94, and N95.

The following will briefly explain an example in which the adjustment level is not high. For example, when the adjustment level is low, the skip number greatly changes in the smoothing process compared to when the adjustment level is high. The following will describe an example in which the set value of the override value is 100% and the adjustment level is low. The smoothing range in this example is narrower than the smoothing range when the adjustment level is high. Furthermore, when the adjustment level is low, the PLC 102 greatly changes the skip number in a smaller number of control cycles. A result of the reduction process is, for example, a result shown in FIG. 11(d). For example, assume that one of the reference numbers is 186 (see N186 in FIG. 11(d)). When the current processing order number is, for example, 150, 160, or 170 (see N150, N160, and N170 in FIG. 11(d)), the smoothing process is not necessary yet. When the current processing order number reaches 180, the reduction process starts. The skip number significantly decreases to 5 and 1, as the unit time repeatedly elapses. The processing order number changes to N180, N185, and N186. In the increase process, in a similar manner as in the reduction process, the skip number significantly increases to 5, and 10, as the unit time repeatedly elapses. The processing order number changes to N186, N187, N192, and N202. In summary, when the adjustment level is low, a steep reduction process and a steep increase process are performed within a narrow range of processing order numbers. To put it differently, when the adjustment level is low, the PLC 102 increases the rate of change of the skip number compared to when the adjustment level is high.

When the adjustment level is medium, the PLC 102 increases the rate of change of the skip number compared to when the adjustment level is high, and decreases the rate of change of the skip number compared to when the adjustment level is low. The detailed explanation of this is not given.

As described above, when the processing order numbers falls within the normal range, the skip number is maintained at the basic skip number. On this account, control based on the set value of the override value is basically performed. When the processing order number falls within the smoothing range, the reduction process and the increase process (i.e., adjustment of the skip number) based on the set value of the override value and the adjustment level are basically performed. This allows the liner L to be positioned always at the target position indicated by the reference data, as shown in, for example, FIG. 12.

### When Override Value Is Changed in Winding Operation

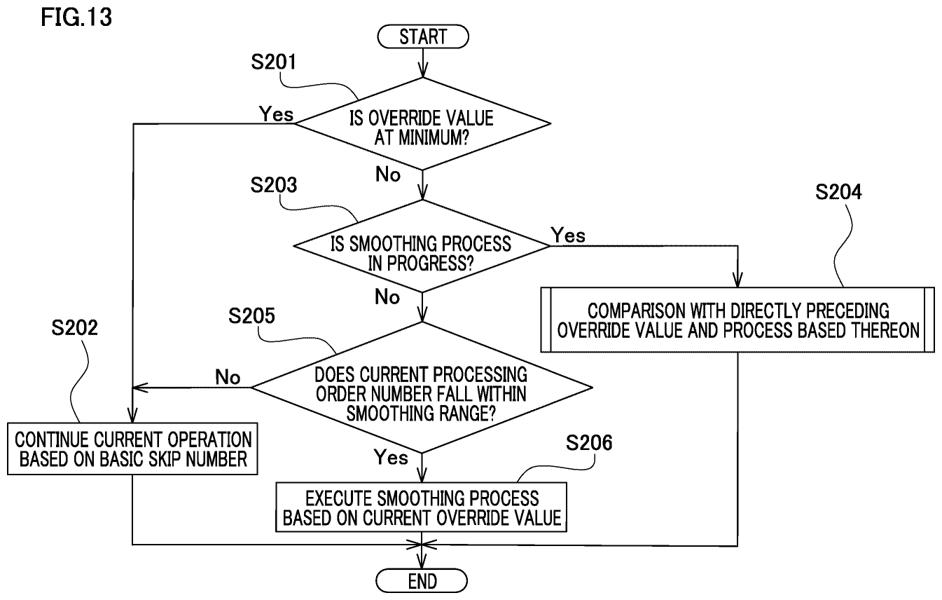

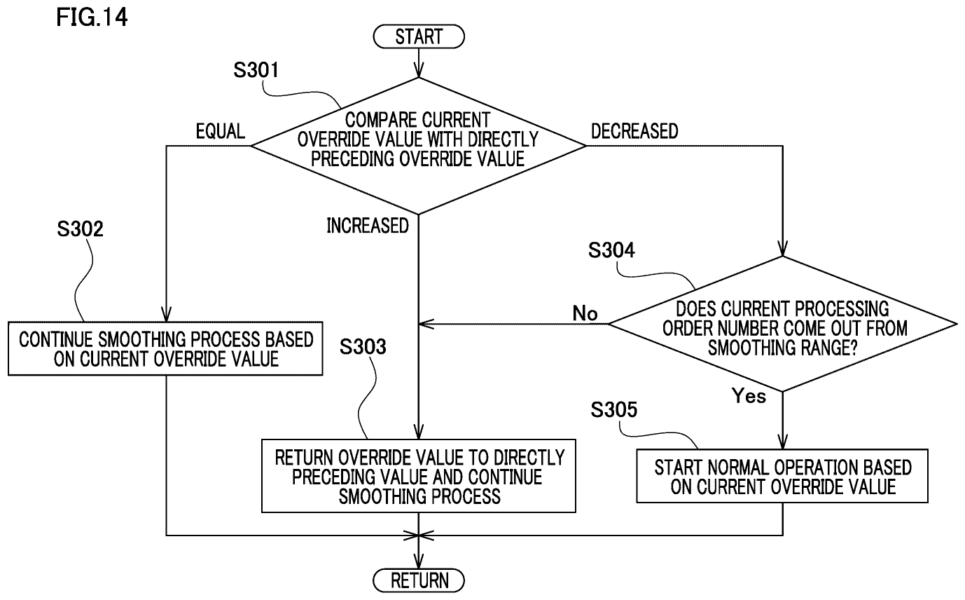

The following will describe a process performed when the operator changes the set value of the override value by operating the selector 103 while the winding operation is in progress, with reference to FIG. 13 and FIG. 14. FIG. 13 is a flowchart showing the process performed when the set value of the override value is changed in the middle. FIG. 14 is a flowchart showing part of the process shown in FIG. 13.

The control shown in the flowchart of FIG. 13 is one of the above-described periodic controls. That is, the PLC 102 executes the steps S201 to S206 each time the unit time elapses.

As described above, the PLC 102 is configured to be able to store a current override value, a directly preceding override value, and a set value of the override value input from the selector 103. The selector 103 is configured to be able to change the override value at any timing (i.e., before and during the operations of the winder 2). Hereinafter, the current override value corresponds to the override value after change. The directly preceding override value corresponds to the override value before change.

To begin with, the PLC 102 temporarily treats an override value input from the selector 103 (hereinafter, this value will be simply referred to as an input value) as a current override value. The PLC 102 determines whether the current override value is the minimum value (10% in the present example) among the options (S201). If the current override value is at the minimum (Yes in S201), the current operation is continued based on the basic skip number (S202). This is because the smoothing process is unnecessary when the override value is at the minimum.

If the current override value is not at the minimum (No in S201), the PLC 102 determines whether the smoothing process is currently being executed (S203). When the smoothing process is being executed (Yes in S203), the PLC 102 compares the current override value with the directly preceding override value and performs a process based on the comparison result (S204). The details will be given later.

When the smoothing process is not being executed (No in S203), the PLC 102 determines whether the current processing order number falls within the smoothing range (S205). This smoothing range refers to a smoothing range corresponding to the current override value (and the adjustment level).

When the current processing order number does not fall within the smoothing range (No in S205), the PLC 102 continues the current operation based on the basic skip number (S202). This is because the smoothing process is unnecessary in this example.

When the current processing order number falls within the smoothing range (Yes in S205), the PLC 102 performs the smoothing process based on the current override value (and the adjustment level) (S206). In this example, the PLC 102 performs the smoothing process by utilizing a skip number data group corresponding to the current override value (and the adjustment level).

The following will describe the details of the above-described step S204 (hereinafter, this will be referred to as a sub process) with reference to FIG. 14. To begin with, the PLC 102 compares the current override value (hereinafter, this will be simply referred to as a current value) with the directly preceding override value (hereinafter, this will be simply referred to as a directly preceding value) (S301). Conditional branch is executed based on a result of the comparison.

When the current value is equal to the directly preceding value, the PLC 102 continues the smoothing process based on the current value (S302). The sub process is completed at this stage.

When the current value becomes larger than the directly preceding value, the PLC 102 returns the current value to be equal to the directly preceding value and continues the smoothing process (S303). To put it differently, the PLC 102 ignores the input value from the selector 103. This is to complete the smoothing process in progress based on the directly preceding override value. The sub process is completed at this stage. When the sub process is executed in the next control cycle, the directly preceding value is maintained at the value before the increase.

When the current value becomes smaller than the directly preceding value, the PLC 102 determines whether the current processing order number comes out from the smoothing range (S304).

When the current processing order number does not come out from the smoothing range (No in S304), the PLC 102 returns the current value to the value identical with the directly preceding value and continues the smoothing process (S303). To put differently, the input value from the selector 103 is ignored also in this example. The sub process is completed at this stage.

When the current processing order number comes out from the smoothing range (Yes in S304), the PLC 102 starts a normal operation based on the current override value (i.e., the winding operation based on the basic skip number). The current value is maintained to be identical with the input value. The sub process is completed at this stage.

In this way, when the set value of the override value is switched by the selector 103 during the winding operations as described above, the PLC 102 adjusts the skip number by comparing the current value with the directly preceding value.

Therefore, even if the override value is large, the skip number is adjusted by the adjustment unit 131 at stages before and after each reference number. This makes it possible to transfer all sets of reference data to the winder 2. On this account, it is possible to prevent an operation that the winder 2 must perform from being skipped. It is therefore possible to perform control closely based on sets of winding data even if at least one set of the winding data (second winding data) of the fiber bundle F is skipped.

In addition to the above, the adjustment level can be changed by the selector 103. Because this makes it possible to gently adjust the skip number, rapid deceleration and rapid acceleration of the winder 2 or the liner L are suppressed. It is therefore possible to perform control further closely based on the winding data.

In addition to the above, it is possible to adjust the skip number in consideration of a change of the override value during the winding operations. Therefore, even if the override value is changed while the winder 2 is in operation, the reference data can be reliably transferred to the winder 2.

The following will describe modifications of the above-described example. The members identical with those in the example above will be denoted by the same reference numerals, and the explanations thereof are not repeated.
(1) The selector 103 may be arranged to be able to differentiate the adjustment level before the reference number from the adjustment level after the reference number. This allows for flexible study as needed during the study phase to identify optimal manufacturing conditions for the product.
(2) In the example above, the selector 103 is configured to be able to change the override value while the winder 2 is in operation. However, the disclosure is not limited to this. The selector 103 may be allowed to change the override value only before the start of the operation of the winder 2, for example.
(3) In the example above, the selector 103 is configured to be able to select the adjustment level from the three options, low, middle, and high. However, the disclosure is not limited to this. The number of the adjustment levels may be two, or may be four or more. Alternatively, the selector 103 may not be allowed to change the adjustment level.
(4) In the example above, the PLC 102 is configured to control the operations of the winder 2. Alternatively, in place of the PLC 102, another computer device (not illustrated) capable of controlling the operations of the winder 2 may be provided.
(5) In the example above, the controller 5 includes the selector 103. However, the disclosure is not limited to this. For example, the computer 101 may be able to function as the selector 103.
(6) In the example above, the options of the override value are 10%, 30%, 50%, and 100%. However, the options of the override value are not limited to them. Furthermore, the minimum value of the override value may be a value different from 10%.
(7) In the example above, it is assumed that the process of generating the first winding data group based on the winding conditions is performed by the external computer 100. However, the disclosure is not limited to this. For example, the computer 101 may generate the first winding data group.

What is claimed is:

1. A numerical controller for a filament winding machine, configured to control the filament winding machine including a winder configured to wind a fiber bundle onto a liner, the numerical controller comprising:
a data converter configured to be able to convert (i) sets of first winding data which are generated in advance based on a winding condition of winding the fiber bundle onto the liner and in each of which information of time is associated with information of a state of the winder into (ii) sets of second winding data in each of which information of a processing order number assigned to correspond to elapse of a predetermined unit time is associated with the information of the state of the winder;
a reference data setter configured to be able to set some of the sets of the second winding data as sets of reference data in advance;
a transferer configured to be able to transfer each of predetermined sets of winding data selected from the sets of the second winding data to the winder, each time the unit time elapses;
an override value setter configured to be able to set an override value that is used for determining a skip number indicating the number of processing order numbers that are skipped when the predetermined sets of the winding data are selected; and
an adjuster configured to be able to adjust the skip number at stages before and after each of reference numbers that are processing order numbers corresponding to the respective sets of the reference data, based on the override value, to allow the transferer to transfer all of the sets of the reference data to the winder.

2. The numerical controller according to claim 1, wherein the adjuster includes a level changer configured to be able to change an adjustment level that relates to an amount of change of the skip number at the stages before and after each reference number, in a state in which a set value of the override value is maintained at a predetermined value.

3. The numerical controller according to claim 2, wherein the level changer is capable of differentiating the adjustment level at the stage before each reference number from the adjustment level at the stage after the each reference number.

4. The numerical controller according to claim 1, wherein
the override value setter is configured to be able to switch the set value of the override value at a given timing, and
when the override value is switched by the override value setter while the winder is in operation, the adjuster adjusts the skip number by comparing the override value after change with the override value before the change.
